(19) United States
(12) Patent Application Publication
(10) Pub. No.: US 2005/0201575 A1
(43) Pub. Date: Sep. 15, 2005

(54) Thermally excited sound wave generating device

(76) Inventors: Nobuyoshi Koshida, Tokyo (JP); Kenji Tsubaki, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/524,585

(22) PCT Filed: Feb. 27, 2004
(86) PCT No.: PCT/JP04/02382

§ 371 Date: Mar. 31, 2005

(30) Foreign Application Priority Data
Feb. 28, 2003 (JP) 200353281
Feb. 28, 2003 (JP) 200353282
Feb. 28, 2003 (JP) 200353283

(51) Int. Cl. H04R 25/00

(52) U.S. Cl. 381/164

(57) ABSTRACT

A thermally induced sound wave generating device comprising a thermally conductive substrate, a head insulation layer formed on one surface of the substrate, and a heating element thin film formed on the heat insulation layer and in the form of an electrically driven metal film, and wherein when the heat conductivity of the thermally conductive substrate is set as αₛ and its heat capacity is set as Cₛ, and the thermal conductivity of the beat insulation layer is set as α_{I} and its heat capacity is set as C_{I}, relation of 1/100≧α_{I}C_{I}/α_{S}C_{S} and α_{S}C_{S}≧100×10⁶ is realized. This is a new technical means capable of greatly improving the function of a pressure generating device based on thermal induction.

### TECHNICAL FIELD

The invention of this application relates to a thermally induced sound wave generating device. More specifically, the invention of this application relates to a new thermally induced sound wave generating device that creates compressional wave of the air by giving heat to the air to generate sound waves and is useful for an ultrasonic sound source, a speaker sound source, an actuator, and the like.

### BACKGROUND ART

Conventionally, various ultrasonic wave generating devices have been known. All of these conventional ultrasonic wave generating devices convert some mechanical vibration into vibration of the air except special ones that use electric spark, fluid vibration, and the like. As a method of using such mechanical vibration, although there are a moving conductor type, a capacitor type, and the like, a method utilizing a piezoelectric element is mainly used in an ultrasonic region. For example, electrodes are formed on both surfaces of barium titanate serving as a piezoelectric material and an ultrasonic electric signal is applied between the electrodes, whereby mechanical vibration is generated and the vibration is transmitted to a medium such as the air to generate ultrasonic waves. However, in sound generating devices utilizing such mechanical vibration, since the sound generating devices have inherent resonance frequencies to the sound generating devices, there arc problems in that frequency bands are narrow, the sound generating devices are susceptible to influences of an ambient environment (temperature, vibration) and the like, and it is difficult to fine and array the sound generating devices.

On the other hand, a pressure wave generating device based on a new generation principle, which does not involve mechanical vibration at all, has been proposed (JP-A-11-300274) (Nature 400 (1999) 853-855). In this proposal, specifically, the pressure wave generating device includes a substrate, a heat insulation layer provided on the substrate, and a heating element thin film that is provided on the heat insulation layer and driven electrically. By providing the heat insulation layer such as a porous layer or a polymeric layer having extremely small thermal conductivity for heat generated from the heating element thin film, a temperature change in an air layer on the surface of a heating clement is increased to generate ultrasonic sounds. Since, the proposed device does not involve mechanical vibration, the device has characteristics that a frequency band is wide, the device is less susceptible to influences of an ambient environment, and it is relatively easy to fine and array the device. Considering a generation principle for such a pressure generating device based on thermal induction, a change in surface temperature at the time when an AC current is applied to the electrically-driven heating element thin film is given by the following expression (1) when thermal conductivity of the heat insulation layer is set as α, a heat capacity per volume thereof is set as C, and an angular frequency thereof is set as ω, and there is output and input of energy per a unit area of q(ω)[W/cm²].
T(ω)=(1−j)\sqrt{2}×1/\sqrt{ωαC}×q(ω) (1)

In addition, a sound pressure generated at that point is given by the following expression (2).
P(ω)=A×1\sqrt{αC}×q(ω) (2)

In short, as shown in FIG. 5, a temperature change of the air is caused (FIG. 5-c) by heat exchange of heat (Fig. 5-b), which is generated from the heating element thin film by an electric current (FIG. 5-a) with a frequency f supplied from a signal source for generating a signal of an ultrasonic frequency, with the air that is a medium around the heating element thin film. This generates a compressional wave of the air, whereby a sound wave with a frequency 2f is generated (FIG. 5-d).

Here, it is seen from the expression (2) that the sound pressure to be generated is larger as the thermal conductivity α and the heat capacity per volume C of the thermal insulation layer are smaller, and is proportional to the output and input q(ω) of energy per a unit area, that is, input electric power. Moreover, thermal contrast of the heat insulation layer and the substrate plays an important role. When a thickness of the heat insulation layer having the thermal conductivity α and the heat capacity per volume C is set as L and there is a thermally conducive substrate having sufficiently large α and C below the heat insulation layer, if the heat insulation layer has a thickness (a thermal diffusion length) of a degree represented by the following expression (3),
L=(2α/ωC)^{0.5} (3)
it is possible to insulate an AC component of generated heat and permit heat of a DC component, which is generated because of a heat capacity of the heating element, to escape to the substrate having the large thermal conductivity efficiently.

However, in the sound wave generating device based on thermal induction, under the present situation, no actual prospects are opened up from the viewpoint of improvement in performance thereof concerning an issue of how a multilayer structure thereof should be and concerning a specific form thereof. Although the sound wave generating device does not involve mechanical vibration at all and has many characteristics, there is a problem in that, when it is attempted to obtain practical output, Joule heat generated by an increase in input power also increases due to increase of input power, it is impossible to permit heat of a DC component to escape completely, and it is impossible to increase a temperature change in the heating element thin film.

A level of a sound pressure to be generated is about 0.1 Pa at the maximum, which is not a satisfactory level. Therefore, further improvement in the performance has been desired.

Thus, it is an object of the invention of this application to provide new technical means that can realize significant improvement in performance for a pressure generating device based on thermal induction that does not involve mechanical vibration and has many characteristics.

### DISCLOSURE OF THE INVENTION

Firstly, the invention of this application provides, as a device for solving the problems, a thermally induced sound wave generating device including: a thermally conductive substrate; a heat insulation layer formed on one surface of the substrate; and a heating element thin film formed on the heat insulation layer and in the form of an electrically driven metal film, and wherein when thermal conductivity of the thermally conductive substrate is set as αₛ and a heat capacity thereof is set as Cₛ, and thermal conductivity of the heat insulation layer is set as α_{I} and its capacity is set as C_{I}, relation of 1/100≧α_{I}C_{I}/α_{S}C_{S} and α_{S}C_{S}≧100×10⁶ is realized.

Secondly, the invention provides the thermally induced sound wave generating device that is characterized in that the thermally conductive substrate consists of a semiconductor or metal. Thirdly, the invention provides the thermally induced sound wave generating device that is characterized in that tile thermally conductive substrate consists of a ceramics substrate.

As described above, the inventors repeated studies earnestly paying attention to thermal contrast of the heat insulation layer and the substrate in order to solve the problems and, as a result of the studies, the invention of this application is derived. The invention is completed on the basis of a totally unexpected new knowledge that performance is improved by selecting materials for the thermally conductive substrate and the heat insulation layer such that the relation described above is realized.

Fourthly, the invention of this application provides the thermally induced sound wave generating device that is characterized in that the heat insulation layer is a porous silicon layer that is formed on one surface of the thermally conductive substrate by anodizing polycrystalline silicon. Fifthly, the invention provides the thermally induced sound wave generating device that is characterized in that the porous silicon layer has silicon grains of a columnar structure at least in a part in the porous silicon layer.

As described above, the invention is derived from the result of the earnest studies by the inventors and is completed on the basis of a totally unexpected new knowledge that, by using the porous silicon layer, which is formed by making polycrystalline silicon porous, as the beat insulation layer, a part of the porous silicon layer plays a role of permitting heat of a DC component to escape to the substrate side efficiently.

Sixthly, the invention of this application provides the thermally induced sound wave generating device that is characterized in that, in the porous silicon layer, dielectric films are formed on surfaces of nanocrystalline silicon. Seventhly, the invention provides the thermally induced sound wave generating device, characterized in that the dielectric films are oxide films. Eighthly, the invention provides the thermally induced sound wave generating device that is characterized in that the dielectric films are nitride films. Ninthly, the invention provides the thermally induced sound wave generating device that is characterized in that the dielectric films are formed according to heat treatment. Tenthly, the invention provides the thermally induced sound wave generating device that is characterized in that the dielectric films are formed according to electrochemical treatment.

The inventors repeated studies earnestly in order to solve the problems and, as a result of the studies, these inventions are completed on the basis of a totally unexpected new knowledge that, in a thermally induced sound generating device that is characterized by including: a thermally conductive substrate; a heat insulation layer consisting of a porous silicon layer that is formed on one surface on the substrate; and a heating element thin film consisting of a metal film that is formed on the heat insulation layer and driven electrically, it is possible to decrease thermal conductivity a in a heat insulation layer and it is possible to increase a generated sound pressure by forming dielectric films on surfaces of nanocrystalline silicon of the porous silicon layer.

### BRIEF DESCRIPTION OF THE DRAWINGS

FIG. 1 is a sectional view illustrating an embodiment mode of a thermally induced sound wave generating device according to the invention of this application

FIG. 2 is a diagram showing a preferred range for a relation between α_{S}C_{S} and α_{I}C_{I}.

FIG. 3 is a schematic sectional view showing a columnar structure of silicon grains.

FIG. 4 is a schematic sectional view showing a state in which dielectric films are formed on surfaces of nanocrystalline silicon.

FIG. 5 is a diagram showing a relation among a frequency, an electric current, beat, temperature, and a sound wave.

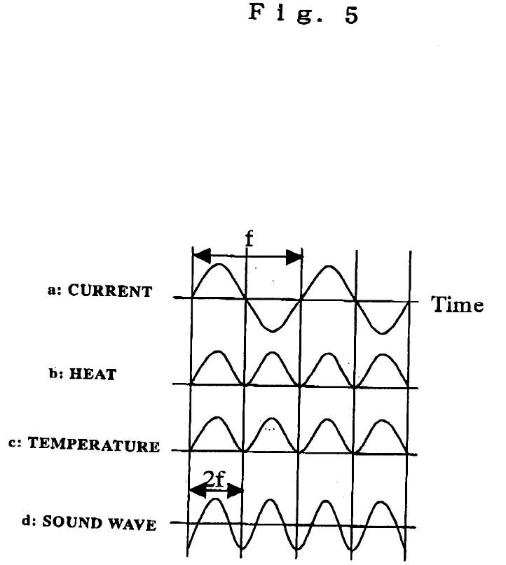

### BEST MODE FOR CARRYING OUT THE INVENTION

The invention of this application has the characteristics as described above. An embodiment mode of the invention will be hereinafter explained.

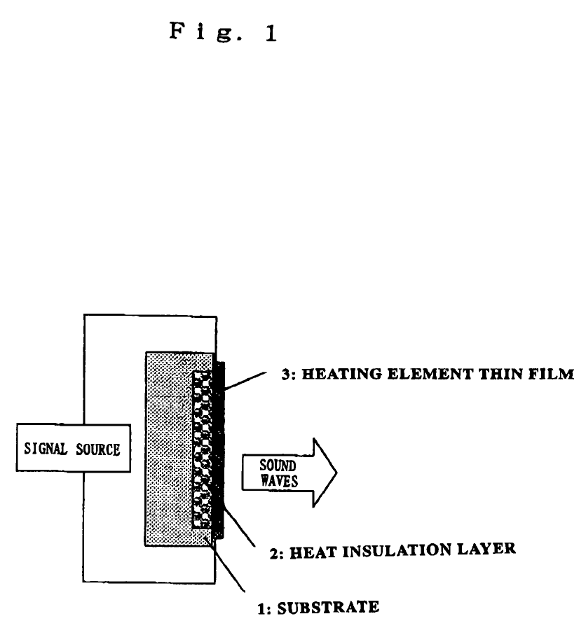

FIG. 1 is a sectional view illustrating an embodiment mode of a thermally induced sound wave generating device according to the invention of this application. In an example of FIG. 1, the thermally induced sound wave generating device includes: a thermally conductive substrate (1), a heat insulation layer (2) consisting of a porous silicon layer that is formed on one surface of the substrate, and a beating element thin film (3) consisting of a metal film that is formed on the heat insulation layer (2) and driven electrically.

When a thickness of a thermally insulating layer having thermal conductivity c and a heat capacity per volume C is set to L and there is a thermally conductive substrate having sufficiently large α and C below the thermally insulating layer, if the heat insulation layer has a thickness (a thermal diffusion length) of a degree represented by the expression (3), It is possible to insulate an AC component of generated heat and permit heat of a DC component, which is generated because of a heat capacity of a heating element, to escape to the substrate having large thermal conductivity.

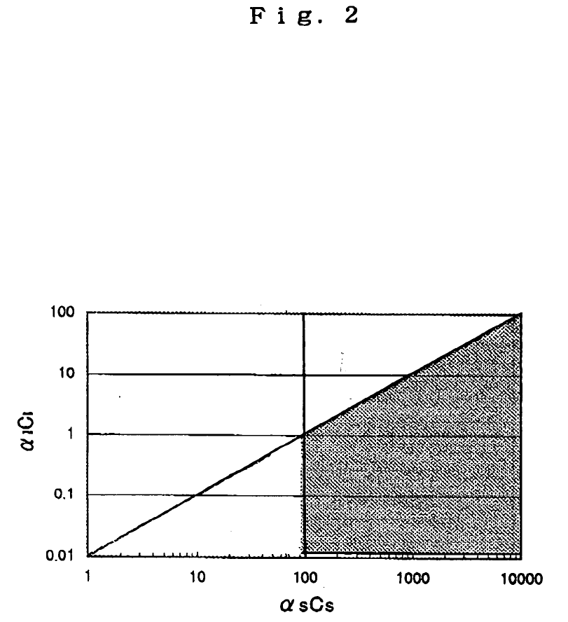

In order to make a flow of this heat more efficient, as shown in FIG. 2, materials for the heat insulation layer and the substrate are selected and combined such that α_{I}C_{I} is within a range of 1/100α_{I}C_{I}/α_{S}C_{S} and α_{S}C_{S}≧100×10⁶. Here, when the materials are combined under a condition of 1/100<α_{I}C_{I}/α_{S}C_{S} and/or α_{S}C_{S}<100×10⁶, it is impossible to permit the heat of the DC component to escape to the substrate side sufficiently and heat accumulates in the heating element metal thin film. Thus, it is impossible to obtain a sufficient temperature change with respect to input and the characteristics of the thermally induced sound wave generating device are deteriorated. In addition, although a lower limit of a value of α_{I}C_{I}/α_{S}C_{S} and an upper limit of α_{S}C_{S} are not specifically provided, practical limits are values of a combination of metal and a high performance heat insulating material that have largest contrast.

αC values of various materials are listed specifically in Table 1.

TABLE 1
Thermal conductivity α, Heat capacity C.

| | Thermal conductivity α | Heat capacity C. | |
|---|---|---|---|
| Type | (W/mK) | (10⁶ J/m³K) | αC (×10⁶) |
| Copper | 398 | 3.5 | 1393 |
| Silicon | 168 | 1.67 | 286 |
| Al₂O₃ | 30 | 3.1 | 93 |
| SiO₂ | 1.4 | 2.27 | 3.2 |
| Polyimide | 0.16 | 1.6 | 0.26 |
| Porous silicon | 0.12 | 0.5 | 0.06 |
| Polystyrene | 0.04 | 0.045 | 0.0018 |
| foam | | | |

αC of a solid body generally takes values in ranges indicated In Table 1 in cases of metal, a semiconductor, an inorganic insulator, and resin. Here, the porous silicon is a porous body of silicon that can be formed by, for example, subjecting a silicon surface to anodic oxidation treatment in a hydrogen fluoride solution. It is possible to obtain a desired porosity and a desired depth (thickness) by appropriately setting an electric current density and treatment time. The porous silicon is a porous material and shows extremely small values in both thermal conductivity and a heat capacity compared with silicon according to a quantum effect (a phonon confinement effect) of nano-sized silicon.

More specifically, it is seen from Table 1 that, for example, when copper or silicon is used as the substrate, the polyimide, the porous silicon, the polystyrene foam, and the like can be used as the heat insulation layer. The combination of these heat insulating materials is only an example and a combination of heat insulating materials can be selected appropriately. However, preferably, heat insulating materials, from which the heat insulation layers can be manufactured in an easy manufacturing process such as fibing/arraying treatment, are selected.

As described above, it is possible to obtain the heat insulation layer (2) consisting of the porous silicon layer by subjecting the silicon surface to the anodic oxidation treatment in a hydrogen fluoride solution. In that case, it is possible to obtain a desired porosity and a desired depth (thickness) by appropriately setting an electric current density and treatment time. The porous silicon is a porous material and shows extremely small values in both thermal conductivity and a heat capacity compared with silicon according to a quantum effect (a phonon confinement effect) of nano-sized silicon. More specifically, whereas the silicon has the thermal conductivity α of 168 W/mK and the heat capacity C of 1.67×10⁶J/m³K, the porous silicon with a porosity of about 70% has the thermal conductivity α of 0.12 W/mK and the heat capacity C of 0.06×10⁶J/m³K.

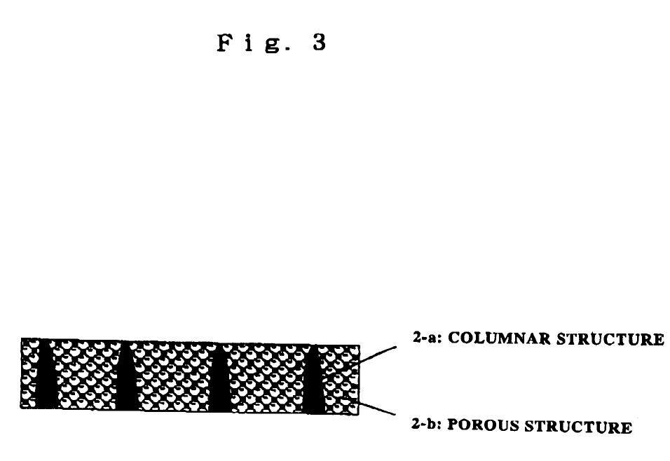

As the silicon, it is possible to use polycrystalline silicon rather than single crystalline silicon. The polycrystalline silicon can be formed by, for example, the plasma CVD method. However, a method of formation is not specifically limited. The polycrystalline silicon may be formed according to the catalyst CVD method or may be obtained by forming a film of amorphous silicon according to the plasma CVD method and, then, applying laser anneal to the amorphous silicon film as heating treatment to thereby polycrystallize the amorphous silicon film. When the polycrystalline silicon is treated according to the anodic oxidation method, as shown in FIG. 3, it is possible to form a porous structure (2-b) in which fine columnar structures (2-a), which are aggregates of grains (crystal particles), are present and silicon nano-sized silicon crystals are present among the fine columnar structures. It is considered that this is because an anodic oxidation reaction of the polycrystalline silicon progresses preferentially in boundaries of the grains, that is, anodic oxidation progresses in a depth direction among columns of the columnar structure, and the columnar silicon grains still remain even after the anodic oxidation. By adopting such a structure, it is possible to permit heat to escape to the substrate side efficiently in the part of the columnar structure while maintaining a macroscopic function as the beat insulation layer.

It is needless to mention that a size and a rate per a unit volume of presence of the silicon grains of this columnar structure change depending on conditions of the anodic oxidation. In the invention of this application, such presence of the silicon grain is presented as a more preferable form.

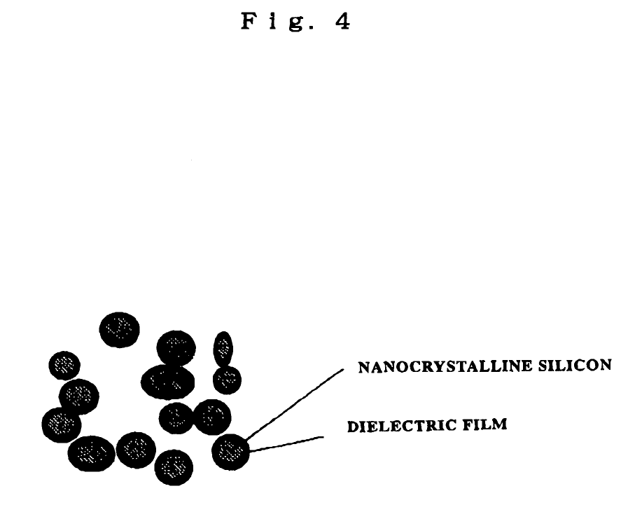

In addition, the inventors of this application paid attention to the fact that thermal conductivity of SiO₂ and Si₃N₄, which were insulating materials, was small compared with thermal conductivity of the silicon that was a skeleton of the porous silicon. In short, as shown in FIG. 4, the inventors found that it was possible to reduce the thermal conductivity α of the porous silicon by forming dielectric films on surfaces of nanocrystalline silicon forming the porous silicon and decreasing thermal conductivity of the skeleton portions. However, since heat capacities C of these insulating materials is large compared with that of the silicon, it-is necessary to appropriately select a thickness of the dielectric films to be formed on the surfaces of the silicon crystals such that the αC value are small.

Although a method of forming these dielectric films is not specifically limited, it is preferable to form the dielectric films according to, for example, heat treatment or electrochemical treatment. It is possible to perform the heat treatment by applying heat under an oxygen atmosphere or a nitrogen atmosphere. A temperature condition, a temperature rise condition, and the like at that point are selected appropriately depending on a material of a substrate to be used or the like. For example, it is possible to perform thermal oxidation treatment in a temperature range of 800° C. to 950° C. for 0.5 to 5 hours. It is possible to perform the electrochemical oxidation treatment by feeding a constant current between the substrate and a counter electrode for a predetermined time in an electrolyte solution such as a sulfuric acid aqueous solution. It is possible to select a current value, a conducting time, and the like at that point appropriately according to a thickness of an oxide film desired to be formed.

As the thermally conductive substrate (1), in order to permit heat of a DC component to escape, it is preferable to use a material having large thermal conductivity α and it is most preferable to use metal. For example, substrates having high thermal conductivity of copper and aluminum are selected. However, the substrate (1) is not limited to these, and it is possible to use a semiconductor substrate such as a silicon substrate. In addition, it is also possible to use a ceramic substrate such as glass. As a form of the substrate, a beat radiation fin may be formed on a rear surface thereof in order to improve heat radiation efficiency.

Next, a material for the heating element thin film (3) is not specifically limited as long as the heating element thin film (3) is a metal film. For example, single metal such as W, Mo, Ir, Au, Al, Ni, Ti, or Pt or a laminated structure of these pieces of metal is % used. It is possible to form the heating element thin film (3) according to vacuum evaporation, sputtering, or the like. In addition, it is preferable to make a thickness of the heating element thin film (3) as small as possible in order to reduce a heat capacity. However, it is possible to select the thickness in a range of 10 nm to 100 nm in order to have an appropriate resistance.

Thus, embodiments will be described below to explain the invention of this application more in detail. It is needless to mention that the invention is not limited by the following embodiments. Embodiments

### First Embodiment

A film of Al was formed 300 nm as a contact electrode for anodic oxidation treatment on a rear surface of a P-type (100) single crystalline silicon substrate (80 to 120 Ωcm) (α_{S}C_{S}=286×10⁶) according to vacuum evaporation. Thereafter, this substrate was subjected to the anodic oxidation treatment at a current density of 100 mA/cm² for eight minutes with platinum as a counter electrode in a solution of HF(55%):EtOH-1:1 to form a porous silicon layer (α_{I}C_{I}=0.06×10⁶) with a thickness of about 50 μm. Finally, W was formed in a thickness of 50 nm as a heating element thin film on the porous silicon layer according to the sputtering method to manufacture an element with an area of 5 mm².

### Second Embodiment

A layer (α_{I}C_{I}=0.26×10⁶) coated with polyimide in a thickness of 50 μm was formed on an upper surface of a substrate of pure copper (thickness 1 mm) (α_{S}C_{S}=1393×10⁶). Finally, W was formed in a thickness of 50 nm as a heating element thin film on the polyimide according to the sputtering method to manufacture an element with an area of 5 mm².

### Third Embodiment

An SiO₂ layer (α_{I}C_{I}=3.2×10⁶) with a thickness of 2 μm was formed on an upper surface of a substrate of pure copper (thickness 1 mm) (α_{S}C_{S}=1393×10⁶) according to the sputtering method. Finally, W was formed in a thickness of 50 nm as a heating element thin film on the SiO₂ according to the sputtering method to manufacture an element with an area of 5 mm².

### FIRST COMPARATIVE EXAMPLE

An Al₂O₃ film (α_{I}C_{I}=93×10⁶) with a thickness of 2 μm was formed on an upper surface of a P type (100) single crystalline silicon substrate (80 to 120 Ωcm) (α_{S}C_{S}=286×10⁶) according to the sputtering method. Finally, W was formed in a thickness of 50 nm as a heating element thin film on the Al₂O₃ film according to the sputtering method to manufacture an element with an area of 5 mm².

### SECOND COMPARATIVE EXAMPLE

A layer (α_{I}C_{I}=0.0018×10⁶) coated with polystyrene foam in a thickness of 100 μm was formed on an upper surface of soda glass (α_{S}C_{S}=1393×10⁶) with a thickness of 1.1 mm. Finally, W was formed in a thickness of 50 nm as a heating element thin film on the polystyrene foam according to the sputtering method to manufacture an element with an area of 5 mm².

Electric power of 50 kHz and 1 W/cm² was supplied to the heating element thin films of the elements obtained in the first to the third embodiments and the first and the second comparative examples to measure output sound pressures with a microphone at a distance of 10 mm from the elements.

A result of the measurement is shown in Table 2.

TABLE 2

| | | Heat insulation | | αₛCₛ | Output sound |
|---|---|---|---|---|---|
| No. | Substrate | layer | α₁C₁/αₛCₛ | (×10⁶) | pressure (Pa) |
| First embodiment | Silicon | Porous silicon | 1/4764 | 280 | 0.28 |
| Second embodiment | Copper | Polyimide | 1/5358 | 1393 | 0.17 |
| Third embodiment | Copper | SiO₂ | 1/435 | 1393 | 0.11 |
| First comparative | Silicon | Al₂O₃ | 1/3.1 | 280 | 0.01 |
| example | | | | | |
| Second comparative | SIO₂ | Polystyrene | 1/1778 | 3.2 | 0.03 |
| example | | foam | | | |

Ultrasonic waves of 100 kHz were generated from the respective elements of the first to the third embodiments and the first and the second comparative examples. It is seen from Table 2 that a sound pressure increases for a combination of 1/100≧α_{I}C_{I}/α_{S}C_{S} and α_{S}C_{S}≧100×10⁶.

### Fourth Embodiment

A film of polycrystalline silicon was formed in a thickness of 3 μm on a surface of a substrate of pure copper with a thickness of 1 mm according to the plasma CVD method.

Thereafter, this substrate was subjected to the anodic oxidation treatment at a current density of 20 mA/cm² for three minutes with platinum as a counter electrode in a solution of HF(SS %):EtOH=1:1 to form a porous silicon layer. Finally, W was formed in a thickness of 50 nm as a heating element thin film on the porous silicon layer according to the sputtering method to manufacture an element with an area of 5 mm². When the porous silicon layer of the obtained element was observed, a columnar structure of silicon grains was observed. Moreover, electric power of 50 kHz and 50 W/cm² was supplied to the heating element thin film of the obtained element to measure an output sound pressure with a microphone at a distance of 10 mm from the element. As a result, generation of an ultrasonic wave of 100 kHz was confirmed and the sound pressure output was 5.8 Pa. A steady-state temperature on the surface of the element at that point was about 50° C.

### THIRD COMPARATIVE EXAMPLE

A film of Al was formed 300 nm as a contact electrode for anodic oxidation treatment on a rear surface of a P-type (100) single crystalline silicon substrate (3 to 20 Ωcm) according to vacuum evaporation. Thereafter, this substrate was subjected to the anodic oxidation treatment at a current density of 20 mA/cm² for three minutes with platinum as a counter electrode in a solution of HF(55%):EtOH=1:1 to form a porous silicon layer with a thickness of about 3 μm. Finally, W was formed in a thickness of 50 nm as a heating element thin film on the porous silicon layer according to the sputtering method to manufacture an element with an area of 5 mm². When the porous silicon layer of the obtained clement was observed, a columnar structure of silicon grains was not observed specifically. Moreover, electric power of 50 kHz and 50 W/cm² was supplied to the heating element thin film of the obtained element to measure an output sound pressure with a microphone at a distance of 10 mm from the element. As a result, generation of an ultrasonic wave of 100 kHz was confirmed and the sound pressure output was 3.8 Pa. A steady-state temperature on the surface of the element at that point was about 80° C.

It was also confirmed from the above that, In the thermally induced sound wave generating device according to the invention of this application, by using the porous silicon layer, which was formed by making polycrystalline silicon porous, as the heat insulation layer, since that portion permits heat of a DC component to escape to the substrate side efficiently, it was possible to generate sound waves efficiently even for high power output.

### Fifth Embodiment

A film of Al was formed 300 nm as a contact electrode for anodic oxidation treatment on a rear surface of a P-type (100) single crystalline silicon substrate (3 to 20 Ωcm) according to vacuum evaporation. Thereafter, this substrate was subjected to the anodic oxidation treatment at a current density of 20 mA/cm² for forty minutes with platinum as a counter electrode in a solution of HF(55%):EtOH=1:1 to form a porous silicon layer with a thickness of about 50 μm. Thereafter, the substrate was subjected to the thermal oxidation treatment at 900° C. for ten minutes in an oxygen atmosphere to form dielectric films consisting of SiO₂ on surfaces of nanocrystalline silicon. Finally, W was formed in a thickness of 50 nm as a heating element thin film on the porous silicon layer according to the sputtering method to manufacture an element with an area of 5 mm².

### Sixth Embodiment

An element was manufactured in the same manner as the fifth embodiment except that the treatment was performed in a nitrogen atmosphere as heat treatment to form a dielectric film consisting of Si₂N₄.

### Seventh Embodiment

An element was manufacture in the same manner as the fifth embodiment except that the electrochemical oxidation treatment was performed to form a dielectric film consisting of SiO₂. More specifically, the treatment was performed at a current density of 5 mA/cm² for 10 minutes with a platinum electrode as a counter electrode in a 1M sulfuric acid aqueous solution.

### FOURTH COMPARATIVE EXAMPLE

An element was manufactured in the same manner as the fifth embodiment except that the thermal oxidation treatment was not performed.

The thermal conductivity at and the heat capacity C of the porous silicon layer were measured for the fifth to the seventh embodiments and the fourth comparative example according to an photo-acoustic method. In addition, electric power of 50 kHz and 1 W/cm² was supplied to the heating element thin films of the obtained elements to measure output sound pressures with a microphone at a distance of 10 mm from the elements.

A result of the measurement is shown in Table 3.

TABLE 3

| | Thermal | | | Output |
|---|---|---|---|---|
| | conductivity | Heat | | sound |
| | α | capacity C. | | pressure |
| No. | (W/mk) | (10⁶ J/m³K) | αC (×10⁶) | (Pa) |
| Fifth embodiment | 0.1 | 1.2 | 0.12 | 0.25 |
| Sixth embodiment | 0.3 | 1.3 | 0.39 | 0.14 |
| Seventh embodiment | 0.1 | 1.1 | 0.11 | 0.26 |
| Fourth comparative | 1.1 | 0.7 | 0.77 | 0.10 |
| example | | | | |

Ultrasonic waves of 100 kHz were generated from the respective elements. From Table 3, by forming the dielectric layer, although the heat capacity C increases slightly, the thermal conductivity decreases and, as a result, a value of αC decreases. Therefore, the output sound pressure to be generated increased.

Consequently, in the thermally induced sound wave generating device according to the invention of this application, in the thermally induced sound wave generating device including the thermally conductive substrate, the heat insulation layer consisting of the porous silicon layer formed on one surface on the substrate, and the heating element thin film consisting of a metal film that is formed on the heat insulation layer and driven electrically, by forming the insulating film on the surfaces of the silicon crystals of the porous silicon layer, it is possible to decrease the thermal conductivity a in the heat insulation layer and it is possible to increase a generated sound pressure.

### INDUSTRIAL APPLICABILITY

As described above in detail, in the thermally induced sound wave generating device according to the invention of this application, the thermally induced sound wave generating device includes: the thermally conductive substrate; the heat insulation layer formed on one surface of the substrate; and the beating element thin film consisting of a metal film that is formed on the heat insulation layer and driven electrically, and, when thermal conductivity of the thermally conductive substrate is set as αₛ, a heat capacity thereof is set as Cₛ, thermal conductivity of the heat insulation layer is set as α_{I}, and a heat capacity thereof is set as C_{I}, materials for the thermally conductive substrate and the heat insulation layer are selected such that a relation of 1/100≧α_{I}C_{I}/α_{S}C_{S} and α_{S}C_{S}≧100×10⁶ is realized. Consequently, it is possible to improve an output sound pressure characteristic significantly.

In addition, in the thermally induced sound wave generating device according to the invention of this application, the porous silicon layer, which is formed by making polycrystalline silicon porous, is used as the heat insulation layer. Consequently, since the silicon grains of the columnar structure permit heat of a DC component to escape to the substrate side efficiently, it is possible to generate sound waves efficiently even for high power output.

Further, in the thermally induced sound wave generating device according to the invention of this application, in the thermally induced sound generating device including; the thermally conductive substrate; the heat insulation layer consisting of the porous silicon layer that is formed on one surface on the substrate; and the heating element thin film consisting of a metal film that is formed on the heat insulation layer and driven electrically, dielectric films are formed on surfaces of nanocrystalline silicon of the porous silicon layer. Consequently, it is possible to decrease thermal conductivity α in a heat insulation layer and it is possible to increase a generated sound pressure.

1. A thermally induced sound wave generating device comprising: a thermally conductive substrate; a heat insulation layer formed on one surface of the substrate; and a heating element thin film formed on the heat insulation layer and in the form of an electrically driven metal film, and wherein when thermal conductivity of the thermally conductive substrate is set as αₛ and its heat capacity is set as cₛ, and thermal conductivity of the heat insulation layer is set as α_{I} and its heat capacity is set as c_{I}, relation of 1/00≧α_{I}C_{I}/α_{S}C_{S} and α_{S}C_{S}≧100×10⁶ is realized.

2. A thermally induced sound wave generating device according to claim 1, characterized in that the thermally conductive substrate consists of a semiconductor or metal.

3. A thermally induced sound wave generating device according to claim 1, characterized in that the thermally conductive substrate consists of a ceramics substrate.

4. A thermally induced sound wave generating device according to claim 1, characterized in that the heat insulation layer is a porous silicon layer that is formed on one surface of the thermally conductive substrate by making polycrystalline silicon porous.

5. A thermally induced sound wave generating device according to claim 4, characterized in that the porous silicon layer has silicon grains of a columnar structure at least in a part in the porous silicon layer.

6. A thermally induced sound wave generating device according to claim 4 or 5, characterized in that, in the porous silicon layer, dielectric films are formed on surfaces of nanocrystalline silicon.

7. A thermally induced sound wave generating device according to claim 6, characterized in that the dielectric films are oxide films.

8. A thermally induced sound wave generating device according to claim 6, characterized in that the dielectric films are nitride films.

9. A thermally induced sound wave generating device according to claim 6, characterized in that the dielectric films are formed according to heat treatment.

10. A thermally induced sound wave generating device according to claim 6, characterized in that the dielectric films are formed according to electrochemical treatment.

11. A thermally induced sound wave generating device according to claim 5, characterized in that, in the porous silicon layer, dielectric films are formed on surfaces of nanocrystalline silicon.

12. A thermally induced sound wave generating device according to claim 7, characterized in that the dielectric films are formed according to heat treatment.

13. A thermally induced sound wave generating device according to claim 8, characterized in that the dielectric films are formed according to heat treatment.

14. A thermally induced sound wave generating device according to claim 9, characterized in that the dielectric films are formed according to heat treatment.

15. A thermally induced sound wave generating device according to claim 7, characterized in that the dielectric films are formed according to electrochemical treatment.

16. A thermally induced sound wave generating device according to claim 8, characterized in that the dielectric films are formed according to electrochemical treatment.

17. A thermally induced sound wave generating device according to claim 9, characterized in that the dielectric films are formed according to electrochemical treatment.
